(19) United States
(12) Patent Application Publication
(10) Pub. No.: US 2002/0119003 A1
(43) Pub. Date: Aug. 29, 2002

(54) Device for placing a drive element on a valve

(76) Inventors: Immanuel Buschatz, Unterensingen (DE); Peter Bader, Marbach (DE); Dieter Stempel, Markgroningen (DE); Dieter Stammerjohann, Kornwestheim (DE)

Correspondence Address: KENNEDY COVINGTON LOBDELL & HICKMAN, LLP, 100 N TRYON STREET, BANK OF AMERICA CORPORATE CENTER, CHARLOTTE, NC, 28202-4006, US

(21) Appl. No.: 10/084,271

(22) Filed: Feb. 27, 2002

(30) Foreign Application Priority Data
Feb. 27, 2001 (DE) 101 09 644.5

(51) Int. Cl. B25G 3/00

(52) U.S. Cl. 403/376

(57) ABSTRACT

A ring for mounting a drive element on a valve using a snap connection is provided with a collar and a plurality of locking elements, which together form a receptacle for a shoulder of the drive element. The locking elements are segments of a sheet metal annulus and extend through slots in the collar to the interior of the ring, and include flanges as tool gripping locations. An O-ring disposed in a slot in the collar radially inwardly biases the locking elements, the leading edges of which are chamfered. The shoulder includes outward projections that are correspondingly chamfered and push the locking elements outward as the drive element is inserted into the ring. As the locking elements recoil, a snap connection is made. The ring may be screwed or snapped onto the valve, and the configuration allows a drive element to be snapped into place using the ring or screwed directly onto the valve using a screw cap, without modifying the drive element.

### CROSS-REFERENCES TO RELATED APPLICATIONS

This application claims the benefit of German patent application 10109644.5, filed Feb. 27, 2001, and incorporated herein by reference.

### BACKGROUND OF THE PRESENT INVENTION

The present invention relates generally to a device for attaching a drive element, such as an actuating drive or a thermostatic operating element, to a valve, and particularly to a ring that can be fastened to a valve to provide a mounting location or receptacle for such a drive element so that the drive element can be mounted with a snap connection.

It is known from German Patent No. DE 299 05 274 U that a drive element that has been provided with an outwardly threaded screw cap can be placed on a valve that has a complementary, inwardly threaded shoulder.

It is also desirable in some applications to have a snap-on drive element, and for that purpose a ring is usually provided with an outer threading and screwed onto the complementary inner threading of the valve shoulder. The ring is further provided with an outwardly open circumferential groove, whereby a drive element can snapped onto and supported on the ring. In order to enable the snap connection, the drive element is provided with opposing pivotable levers that have inwardly directed hooklike ends for engaging with the groove in the ring. The levers are spring-loaded to ensure a firm connection in the engaged position.

The chief drawback to this system is that substantial changes to the drive element are required in order to make it usable in a snap-on configuration. What is needed, therefore, is an attachment system that permits attachment of the drive element in either a screw-on or a snap-on configuration, so that the same drive element may be used for either.

### OBJECT AND SUMMARY OF THE PRESENT INVENTION

It is accordingly an object of the present invention to meet the above-identified need by enabling either snap-on or screw-on attachment of a drive element to a valve. This object is addressed by providing the ring with an inwardly directed collar and with locking or snap elements that extend into the ring. The locking elements are designed to be radially resilient so that, together with the collar, they form a receptacle for a shoulder of the drive element, which is in turn provided with outwardly directed projections and which can be snapped into the receptacle.

The device according to the present invention represents an improvement over known attachment devices in that virtually no change in the drive element is needed, whether a snap-on or screw-on configuration is desired. The drive element can be selectively placed directly on the valve by engaging the complementary threads using a screw cap, or a ring according to the present invention can be screwed onto the valve and the drive element snapped into the ring. The shoulder of the drive element, which includes either a circumferential projection or several outwardly directed projections, serves in the same manner to receive a screw cap or to snap into engagement with the receptacle formed by the locking elements.

### BRIEF DESCRIPTION OF THE DRAWINGS

Further features, embodiments, and advantages of the present invention will become apparent from the following detailed description with reference to the drawings, wherein:

FIG. 1 is a side view, partially broken away, of a drive element fastened to a valve using a ring according to the present invention;

FIG. 2 is a cross-sectional view of a connection device according to the present invention, taken along line II-II in FIG. 1 and in the direction of the arrows pointing theretoward; and

FIG. 3 is a cross-sectional view of a connection device as in FIG. 2, taken along line III -III and in the direction of the arrows pointing theretoward.

### DETAILED DESCRIPTION OF THE PREFERRED EMBODIMENTS

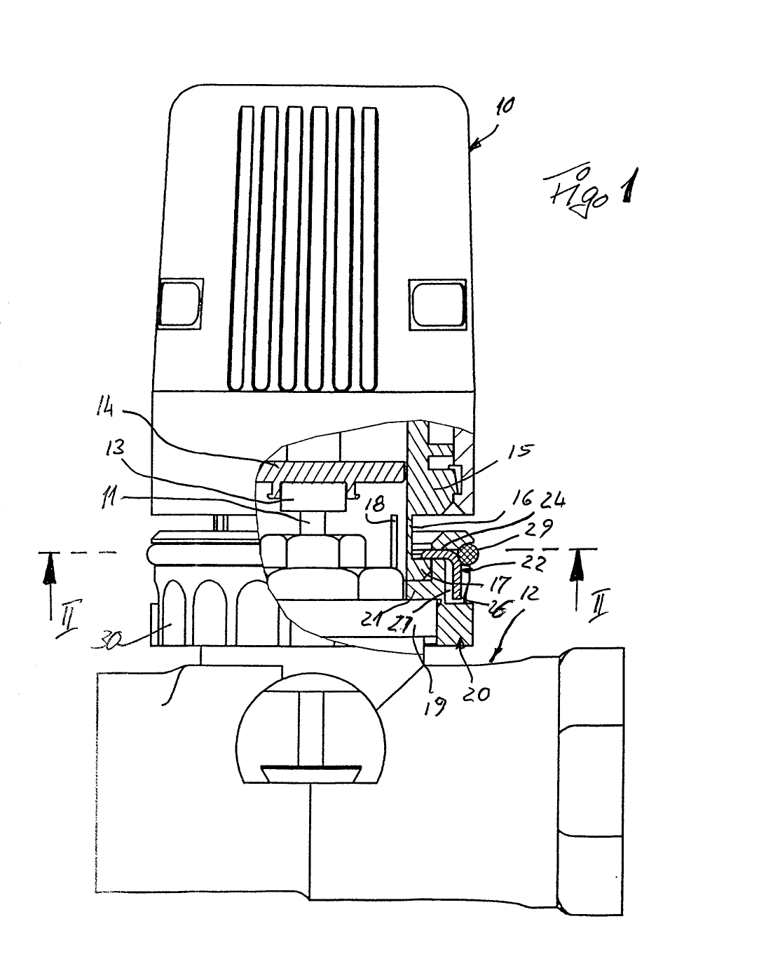

Referring now to FIG. 1, drive element 10 corresponds substantially to the design according to German Patent No. DE 299 05 274 U, so that reference may be made to the descriptions therein for comparative purposes. A spring-loaded valve tappet 11 of a valve 12 acts via a spacer 13 on a pressure plate 14 of the drive element 10. The body 15 of the drive element 10 is provided with an axial shoulder 16 on whose end a circumferential, outwardly extending projection 17 is formed. The shoulder 16 is provided with several axial slots 18 distributed over the circumference of the shoulder, the purpose of which slots is to enable the use of a screw cap, which will be referred to later.

The valve 12 has a shoulder 19 concentric with the tappet 13 and having an outer threading. A ring 20, which is provided with an inner threading, is screwed onto the shoulder 19.

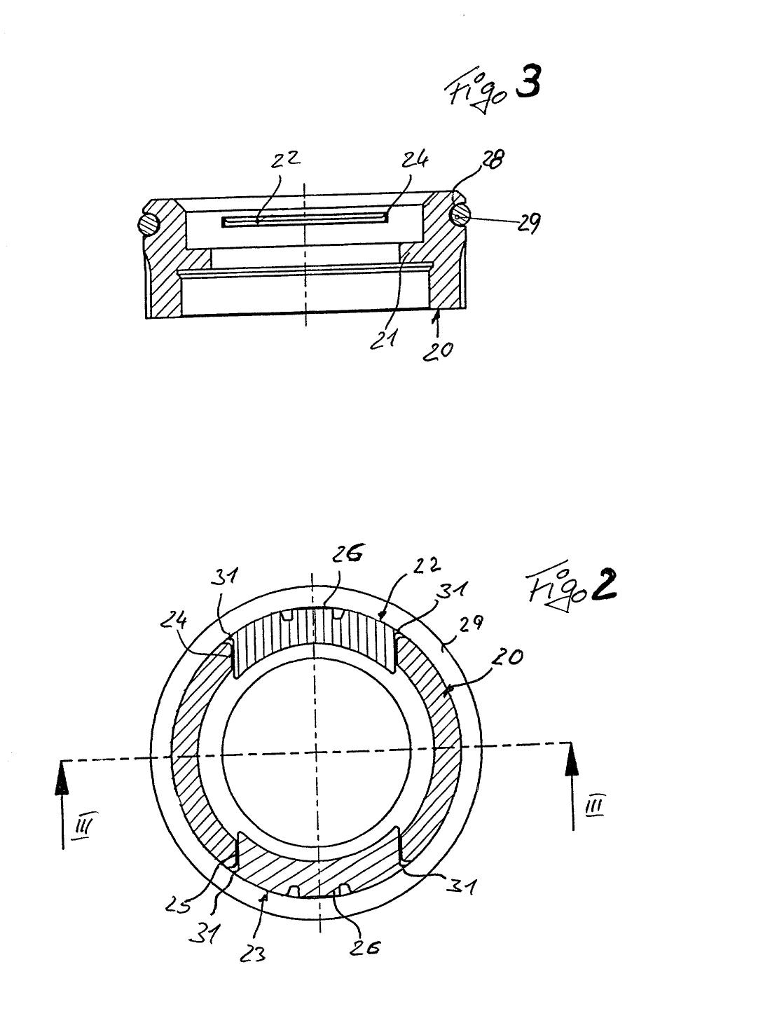

Referring now to FIGS. 1-2, the ring 20 is further provided with an inwardly projecting, circumferential collar 21, which is placed on the front side of the shoulder 19 of the valve 12. The ring is provided with two diametrically opposite locking or snap elements 22, 23 spaced from the collar 21 at an axial interval in the direction of the drive element 10, such that a receptacle for the projection (or projections) 17 of the shoulder 16 is formed. Locking elements 22, 23 are preferably formed as segments of a sheet-metal annulus, which segments are inserted into the diametrically opposite radial slots 24, 25 of the ring 20. Locking elements 22, 23 are each provided with a bent flange 26 that engages in a recess 27 of the ring 20. These flanges 26 serve as a means by which a tool, such as a screwdriver, may be used to loosen the catch to permit the drive element to be released from the ring. A nose 31 formed on each side of both locking elements 22,23 limits the penetration depth of locking elements 22, 23 into slots 24, 25.

Referring now to FIG. 3, slots 24, 25 are located in a circumferential annular groove 28 in the ring 20. A spring element, such as O-ring 29, is placed into the annular groove 28. The spring element 29 exerts an inwardly directed radial force on the locking elements 22, 23 and holds the locking elements 22, 23 in the locked position after the projections 17 have been snapped into the ring.

Referring again to FIG. 1, the lower, outer edges of the projections 17 have been chamfered, and the leading edge of locking elements 22, 23, which edge faces the chamfered lower, outer edge of the projections 17, has been correspondingly and complementarily chamfered. As the drive element 10 is inserted into the rings, the chamfered edges of the projections 17 press against the chamfered edges of the locking elements 22, 23, which serves to direct the locking elements 22, 23 outward against the pressure of the spring element 29. As the projections 17 slip past the locking elements 22, 23, the inward pressure of the spring element 29 again forces the locking elements 22, 23 into a locked position, thus snapping the drive element 10 into place within the ring 20.

As may be seen particularly in FIG. 1, in another feature of the present invention, the ring 20 is provided on its outer circumference below the spring element 29, with a number of axial recesses 30 that are distributed more or less uniformly over the circumference so as to form a gripping surface. The gripping surface permits the ring 20 to be manually screwed sufficiently firmly onto the shoulder 19 of the valve 12 during assembly.

In an alternative embodiment of the present invention, the ring 20 is clipped onto the shoulder 19 of the valve 12, which shoulder has been provided with a circumferential collar surrounded by a single circumferential snap nose or several individual snap noses.

The present invention permits a drive element to be mounted very easily by means of a snap connection, but because the drive element has not been modified, the drive may be used just as easily with a screw cap. As seen in FIG. 1, the axial slots 18 of shoulder 16 are not necessary for the snap connection, although they are useful if the connection is to be made using a screw cap. Because locking elements 22, 23 yield as the drive element is snapped into place, projections 17 need not be made so as to yield resiliently. In fact, in order to make the connection more secure, shoulder 16 may be provided with a radial stiffening ring (not shown in detail).

The present invention is particularly advantageous when implemented at a construction site, and especially so if an electric heating device is used to manipulate the drive element. Because the drive element can be attached to the valve fairly easily without custom modifications, an electrician can make any necessary electrical connections to the drive element and then snap the drive element into the ring mounted on the valve.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A ring for mounting a drive element on a valve using a snap connection, the drive element including a shoulder having at least one outwardly directed projection, the ring comprising:
an inwardly directed collar; and
a plurality of resiliently radially displaceable locking elements extending into the ring;
wherein the collar and the locking elements together form a receptacle for the shoulder for engaging with the at least one projection.

2. The ring of claim 1, further comprising:
an inner screw threading complementary to and engageable with an outer screw threading of the valve.

3. The ring of claim 1, wherein the collar further comprises a plurality of radially directed slots and the locking elements comprise segments of an annulus placed in the slots.

4. The ring of claim 3, wherein each of the segments comprises at least one nose for restricting inward radial movement of the segment.

5. The ring of claim 3, wherein each of the locking elements further comprises a flange as a tool gripping position.

6. The ring of claim 3, wherein each of the annular segments is chamfered on an inner edge facing the drive element.

7. The ring of claim 1, further comprising a spring element for inwardly radially biasing each of the locking elements.

8. The ring of claim 1, further comprising a groove disposed circumferentially on the outside of the ring.

9. The ring of claim 8, further comprising a circumferential spring element located in the groove.

10. The ring of claim 1, further comprising a gripping surface for facilitating mounting of the ring on the valve.

11. The ring of claim 1, further comprising a snap connection for engaging with the valve.
